(19) United States
(12) Patent Application Publication
(10) Pub. No.: US 2014/0245332 A1
(43) Pub. Date: Aug. 28, 2014

(54) COOLING APPARATUS COMBINED WITH OPTICAL DISK DRIVE MODULE

(71) Applicant: Toshiba Samsung Storage Technology Korea Corporation, Suwon-si (KR)

(72) Inventors: Jung-bae Oh, Suwon-si (KR); Seung-man Han, Suwon-si (KR)

(73) Assignee: Toshiba Samsung Storage Technology Korea Corporation, Suwon-si (KR)

(21) Appl. No.: 14/187,554

(22) Filed: Feb. 24, 2014

(30) Foreign Application Priority Data
Feb. 25, 2013 (KR) 10-2013-0020022

(51) Int. Cl. G06F 1/20; G11B 33/14

(52) U.S. Cl. CPC G06F 1/20; G11B 33/144
USPC 720/649

(57) ABSTRACT

Provided is a cooling apparatus of a portable computer. The cooling apparatus includes one or more ventilation holes formed on the body thereof, and a cooling fan module mounted in the body. An optical disk drive (ODD) module mounted in the body drives the cooling fan module thereby reducing power consumption of the cooling module.

### CROSS-REFERENCE TO RELATED APPLICATION(S)

This application claims the benefit under 35 USC §119 (a) of Korean Patent Application No. 10-2013-0020022, filed on Feb. 25, 2013, in the Korean Intellectual Property Office, the entire disclosure of which is incorporated herein by reference for all purposes.

### BACKGROUND

1. Field

The following description relates to a cooling apparatus for a computer, and more particularly, to a cooling apparatus combined with an optical disk drive (ODD) module.

2. Description of Related Art

In general, a notebook computer is a type of portable computer that is slim in design for convenient portability. To make a notebook computer slimmer, a motherboard and a detachable battery that are mounted in the notebook computer may be integrally formed with a body case of the notebook computer. However, by doing so, heat that is generated by a central processing unit (CPU), and the like on the motherboard, may become concentrated at a predetermined region of the body case such as a bottom plate to which the motherboard and the battery are assembled. In particular, by integrating the motherboard and battery with the body case of the notebook, the integration of internal circuits is increased. The result is a signal processing speed of the CPU and a rotation speed of a hard disk are also increased, however, a greater amount of heat is generated.

In order to solve this problem, a notebook computer may include at least one heat dissipating fan that forcibly exhausts inner heat to the outside. In this regard, a forcible exhaustion path of the heat dissipating fan has a plurality of holes.

However, heat dissipation which is performed by the heat dissipating fan has a relatively small heat dissipation effect. For example, in a warmer temperature environment, an inner temperature of the notebook computer may be sharply increased due to heat from the CPU and the like, and the fan may be unable to cope with such drastic changes in heat which may damage various chips on the motherboard or may decrease a lifetime of the battery.

As another example, the notebook computer may be cooled by a structure that is separate from the notebook computer. This cooling method requires a separate cooling apparatus that has a cooling fan that is disposed at the bottom plate where the heat of the notebook computer concentrates. Here, the separate cooling apparatus cools the notebook computer by moving an air flow to the bottom plate of the notebook computer.

However, because the separate cooling apparatus having a cooling fan operates regardless of a temperature of the notebook computer, the cooling method may cause unnecessary power consumption. Furthermore, because a speed of the cooling fan must be manually adjusted, it is difficult to efficiently drive the cooling fan to react to changes in temperature.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, there is provided a cooling apparatus of a computer, the cooling apparatus including a body in which one or more ventilation holes are formed, a cooling fan module mounted in the body, and an optical disk drive (ODD) module mounted in the body and being electrically connected to the cooling fan module, the ODD module being configured to write data to an optical disc and/or read data from the optical disc, and to electrically drive the cooling fan module to cool the computer.

The cooling fan module may comprise a cooling fan for generating an air flow, and a driving unit for driving the cooling fan.

The ODD module may comprise a housing that is mounted in the body, a rotation unit that rotates the optical disc in the housing, an optical pickup unit that moves in a radial direction of the optical disc and accesses data from the optical disc, and a control unit that controls the rotation unit and the optical pickup unit.

The control unit may be connected with the driving unit to control the driving of the cooling fan.

The optical pickup unit may comprise a temperature sensor, and the control unit may be configured to control the driving of the cooling fan based on a temperature value that is detected by the temperature sensor.

The temperature sensor may comprise a thermistor.

The housing may comprise one or more air outlet holes.

The body may comprise at least one connector unit, and the ODD module may be connected with the at least one connector unit.

The connector unit may comprise a universal serial bus (USB) slot.

In response to the computer being disposed at a surface of the body in which the one or more ventilation holes are formed, an air flow that is generated by the cooling fan module may pass through the one or more ventilation holes and move toward the computer.

In an aspect, there is provided an optical disc drive, including a tray configured to receive an optical disc, a rotator configured to rotate the optical disc, an optical pickup configured to slide in a radial direction of the optical disc and to read and/or write signals to and/or from the optical disc during rotation, and a controller configured to control a cooling apparatus of a computer based on a temperature of the computer.

The optical disc drive may be included within the cooling apparatus.

The optical disc drive may further comprise a temperature sensor configured to detect the temperature of the computer.

The controller may be further configured to adjust the speed of the rotator based on a change in temperature of the computer.

The controller may be further configured to transmit a driving current to the cooling apparatus to start the cooling apparatus, in response to an increase in temperature of the computer.

The controller may be further configured to disable a driving current to the cooling apparatus, in response to a decrease in temperature of the computer.

Other features and aspects will be apparent from the following detailed description, the drawings, and the claims.

### BRIEF DESCRIPTION OF THE DRAWINGS

FIG. 1 is a diagram illustrating an example of a cooling apparatus of a portable computer.

FIG. 2 is a diagram illustrating another example of the cooling apparatus of a portable computer of FIG. 1.

FIG. 3 is a diagram illustrating an example in which an optical disk drive (ODD) module is connected with a cooling fan module in the cooling apparatus of FIG. 2.

FIG. 4 is a diagram illustrating an example of the ODD module in the cooling apparatus of FIG. 2.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

While the examples described herein refer to a portable computer, it should be appreciated that these examples herein are not limited thereto. Instead, it is understood that the cooling apparatus described herein may be incorporated into various types of terminals, for example, a personal computer, a laptop computer, a tablet, a mobile phone, a gaming console, a set-top box, a television, a Blu-ray player, a CD/DVD player, and the like.

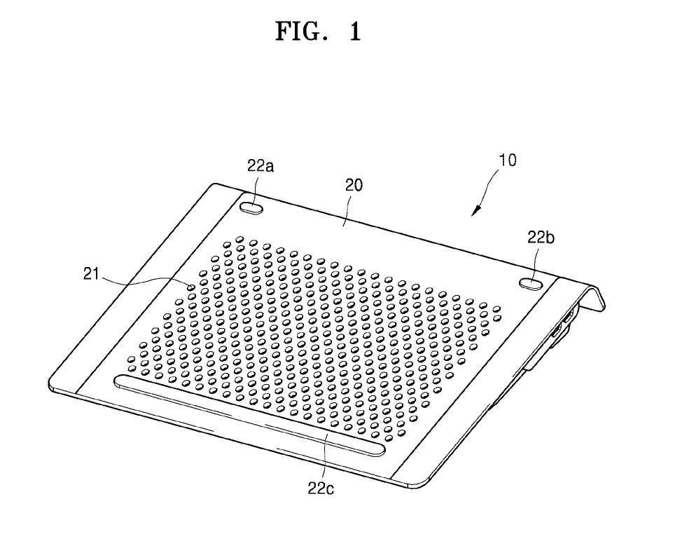

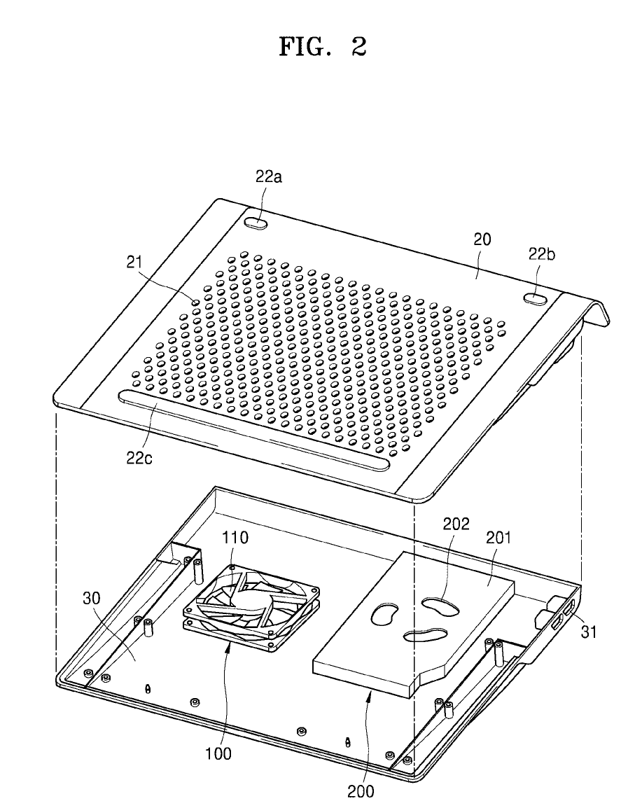

FIG. 1 illustrates an example of a cooling apparatus 10 of a portable computer. FIG. 2 illustrates another example of the cooling apparatus 10 of a portable computer of FIG. 1.

Referring to FIGS. 1 and 2, inside the body of the cooling apparatus 10 is a cooling fan module 100 and an optical disk drive (ODD) module 200. The cooling fan module 100 includes a top plate 20 and a bottom plate 30 and internally forms an air flow path. Each of the top plate 20 and the bottom plate 30 may be formed of a plastic injection-molded product. However, materials for the top plate 20 and the bottom plate 30 are not limited thereto. As another example, the top plate 20 and the bottom plate 30 may be formed of a metal material such as aluminum.

A plurality of ventilation holes 21 are formed in the top plate 20. As an example, the ventilation holes 21 may be equally spaced apart over an entire portion of the top plate 20, so that the portable computer may be effectively cooled. In FIG. 2, the ventilation holes 21 are formed over an area corresponding to the locations of the cooling fan module 100, the ODD 200, and the areas in between the cooling fan module 100 and the ODD 200. However, it should be appreciated that a shape and/or a total number of the ventilation holes 21 may be different. Supporting parts 22a, 22b, and 22c for supporting the portable computer are formed on the top plate 20.

A plurality of air inlet holes (not shown) may be used to intake air into a cooling fan 110. Here, the inlet holes may be formed in the bottom plate 30. In the present example, the bottom plate 30 and the top plate 20 may be separate members. However, in other examples, the bottom plate 30 and the top plate 20 may be integrally formed.

In this example, a single cooling fan module 100 is formed in the body unit at a side of the ODD module 200. However, a total number of cooling fan modules and a position of the ODD module 200 may be changed.

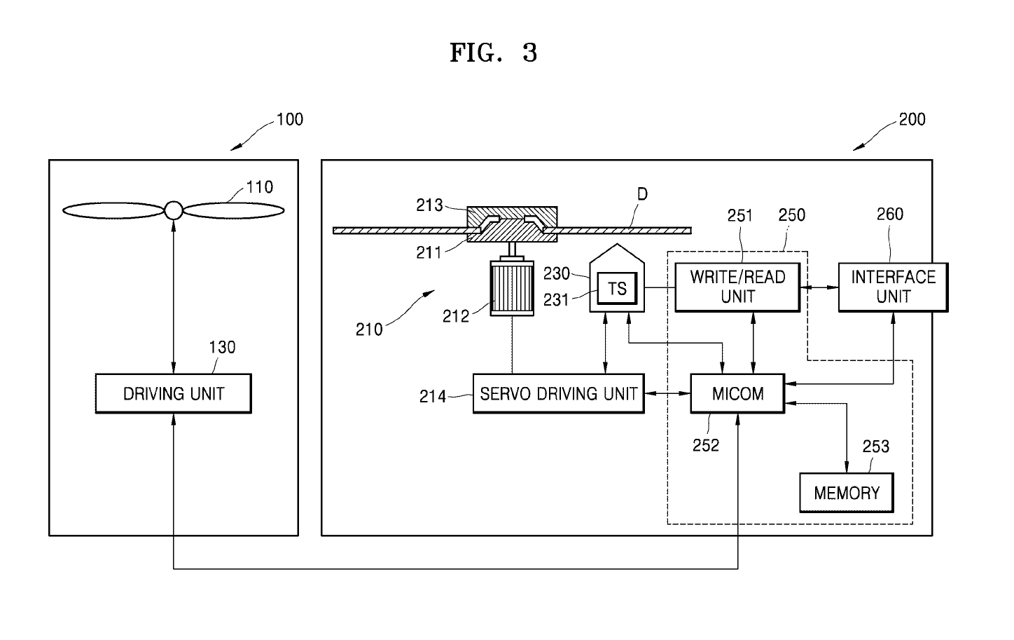

The cooling fan module 100 may include the cooling fan 110 and a driving unit 130 (refer to FIG. 3) for driving the cooling fan 110. While the cooling fan 110 is driven by the driving unit 130, air flow that is generated by driving the cooling fan 110 may be exhausted from the portable computer via the ventilation holes 21. Although not illustrated, the cooling fan module 100 may further include a thermoelement to increase a cooling efficiency.

The ODD module 200 is mounted in the body of the cooling apparatus 10. The ODD module 200 is connected with the portable computer via a connector unit 31 that is formed within the body. A size and shape of the connector unit 31 may be changed according to embodiments. In the present example, the connector unit 31 may have a form of a universal serial bus (USB) slot.

The ODD module 200 includes a housing 201 that protects an inner structure of the ODD module 200. For example, the ODD module 200 may be an external module, and may write data to an optical disk and read written data from the optical disk. The ODD module 200 is connected with the cooling fan module 100. According to various aspects, the driving of the cooling fan module 100 is controlled by the ODD module 200.

As described herein, when an upper portion of a computer is placed or otherwise installed on top of the top plate 20 of the cooling fan module 100, the cooling fan module 100 may detect a temperature of the upper portion of the computer. Based on the detected temperature, the cooling fan module 100 can determine whether to cool the upper portion of the computer, or whether a cooling operation is not to be performed at the time.

FIG. 3 illustrates an example of the ODD module 200 that is connected with the cooling fan module 100 in the cooling apparatus 10 of FIG. 2.

Referring to FIG. 3, the ODD module 200 includes a rotation unit 210, an optical pickup unit 230, and a control unit 250. The rotation unit 210 rotates the optical disk. Here, the rotation unit 210 includes a turntable 211, a spindle motor 212, a clamp 213, and the like. The optical pickup unit 230 slides in a radius direction of the optical disk and accesses data from the optical disk.

A temperature sensor 231 may be formed in the optical pickup unit 230. For example, a thermistor may be used as the temperature sensor 231. The temperature sensor 231 may detect a temperature around the optical pickup unit 230. By detecting the temperature around the optical pickup unit 230, a speed of the spindle motor 212 may be adjusted and a speed of the optical disk D may be controlled. As another example, the temperature sensor 231 may detect a temperature value of the portable computer arranged on the top plate 20 of the body unit.

Table 1 below illustrates an example of a test result of using the cooling apparatus 10 shown in FIG. 1. The test was performed by arranging the portable computer on the top surface of the cooling apparatus 10, and an actual temperature of a bottom surface of the portable computer and a detected temperature of the bottom surface, which was detected by the temperature sensor 231 of the optical pickup unit 230, were compared.

TABLE 1

| | Actual | Detection | |
|---|---|---|---|
| | temperature | temperature | |
| | of portable | by temperature | Temperature |
| | computer (° C.) | sensor (° C.) | difference (° C.) |
| 1 | 75 | 73.5 | 1.5 |
| 2 | 70 | 67.8 | 2.2 |

Referring to Table 1, the actual temperature of the bottom surface of the portable computer, and the detected temperature by the temperature sensor 231 were compared twice. As a result, the temperature difference between the actual temperature of the bottom surface of the portable computer and the detection temperature by the temperature sensor 231 was about 1 or 2° C. Such a temperature difference does not adversely affect overheating of the portable computer, therefore, it is possible to prevent the portable computer from overheating by measuring the temperature of the portable computer indirectly by the temperature sensor of ODD.

In this example, because a distance between the ODD module 200 and the portable computer arranged at the top plate 20 of the cooling apparatus 10 is decreased due to the slimness of the ODD module 200, a relatively accurate temperature reading can be performed. Thus, although a temperature sensor is not separately arranged at the cooling apparatus 10, and because the distance between the ODD and the computer is decreased, it is possible to satisfactorily detect the temperature value of the portable computer using the temperature sensor 231 that is arranged in the optical pickup unit 230.

The control unit 250 is connected with a servo driving unit 214 to control the servo driving unit 214 to apply a driving signal to the optical pickup unit 230 and the rotation unit 210 to control the driving of the optical pickup unit 230 and the rotation unit 210. In this example, the control unit 250 includes a write/read unit 251, a micom 252, and a memory 253, and is formed as a digital signal processor integrated circuit (IC) in which the write/read unit 251, the micom 252, and the memory 253 are integrated.

According to various aspects, the control unit 250 is connected with the cooling fan module 100. In this example, the control unit 250 is connected with the driving unit 130 of the cooling fan module 100. The control unit 250 may compare a temperature value detected by the temperature sensor 231 with a reference temperature value. Accordingly, if the detected temperature value exceeds the reference temperature value, the control unit 250 may apply a driving signal to the driving unit 130. By doing so, only when the portable computer is in an overheated state in which a temperature of the portable computer exceeds the reference temperature value, does the cooling fan 110 operate. Accordingly, unnecessary power consumption may be reduced.

According to various aspects, the control unit 250 may adjust a rotation speed of the cooling fan 110 according to a difference between the reference temperature value and the temperature value detected by the temperature sensor 231. For example, if the difference between the reference temperature value and the temperature value detected by the temperature sensor 231 is equal to or greater than a predetermined temperature value, the control unit 250 may increase the rotation speed of the cooling fan 110. As another example, if the difference is less than the predetermined temperature value, the control unit 250 may maintain or decrease the rotation speed of the cooling fan 110. Accordingly, based on a change in temperature, the control unit 250 may adjust the rotation speed of the cooling fan 110 such that power is not unnecessarily consumed.

In a conventional art, when a user arbitrarily determines a temperature of the portable computer and manually operates a cooling fan, instead of detecting the temperature by the temperature sensor 231, the user determination may be incorrect. Accordingly, depending on the user, some users may drive a cooling fan when the computer is at a low temperature that does not require a cooling operation, and thus, power may be unnecessarily consumed. Also, when a user manually adjusts a speed of a cooling fan according to user determination, a determination reference may be subjective based on the individual user, and the user determination may be incorrect and thus the portable computer may not be efficiently cooled. In contrast, because the temperature sensor 231 in the ODD module 200 is used, the portable computer may be efficiently cooled, without addition of a separate temperature sensor and without user interaction.

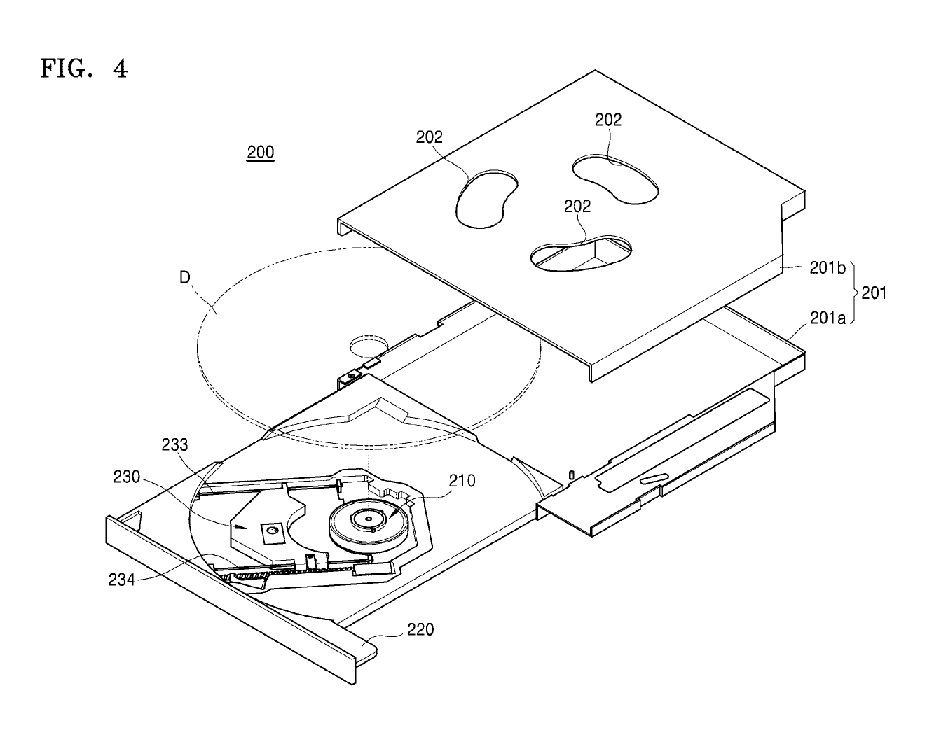

FIG. 4 illustrates an example of the ODD module 200 in the cooling apparatus 10 of FIG. 2. Referring to FIG. 4, the ODD module 200 includes a housing 201, the rotation unit 210 mounted in the housing 201, the optical pickup unit 230 mounted in the housing 201, and the control unit 250 (refer to FIG. 3) mounted in the housing 201.

In this example, the housing 201 includes a main chassis 201a, and a cover 201b that forms a predetermined space between the main chassis 201a and the cover 201b by covering a top portion of the main chassis 201a. Also, a tray 220 may slide within an inner space of the main chassis 201a.

The rotation unit 210 may rotate while the optical disk is mounted thereto. Here, the optical pickup unit 230 may write data by irradiating light to the optical disk or read written data from the optical disk. The optical pickup unit 230 may be guided to linearly move in the radius direction of the optical disk, by a plurality of guide shafts 233 and 234 that are separated from each other by a predetermined distance.

One or more air outlet holes 202 may be formed in the housing 201. In this example, because the air outlet holes 202 are formed in the housing 201, an air flow that is generated due to rotation of the optical disk D may be exhausted from the housing 201 to the outside. The air flow that is exhausted from the housing 201 may move through the ventilation holes 21 of the body unit to thereby cool the portable computer. In this example, the air outlet holes 202 are formed in a top surface of the cover 201b. However, locations of the air outlet holes 202 are not limited thereto. For example, the air outlet holes 202 may be formed in a side surface of the cover 201b or a side surface of the main chassis 201a.

According to various aspects, provided herein is a cooling apparatus of the portable computer and the cooling method thereof. The cooling apparatus may include a cooling fan module that is controlled by an ODD module. Accordingly, the cooling apparatus may be driven by a function of the ODD and may reduce power consumption of the cooling fan.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A cooling apparatus of a computer, the cooling apparatus comprising:
a body in which one or more ventilation holes are formed;
a cooling fan module mounted in the body; and
an optical disk drive (ODD) module mounted in the body and being electrically connected to the cooling fan module, the ODD module being configured to write data to an optical disc and/or read data from the optical disc, and to electrically drive the cooling fan module to cool the computer.

2. The cooling apparatus of claim 1, wherein the cooling fan module comprises a cooling fan for generating an air flow, and a driving unit for driving the cooling fan.

3. The cooling apparatus of claim 2, wherein the ODD module comprises a housing that is mounted in the body, a rotation unit that rotates the optical disc in the housing, an optical pickup unit that moves in a radial direction of the optical disc and accesses data from the optical disc, and a control unit that controls the rotation unit and the optical pickup unit.

4. The cooling apparatus of claim 3, wherein the control unit is connected with the driving unit to control the driving of the cooling fan.

5. The cooling apparatus of claim 4, wherein the optical pickup unit comprises a temperature sensor, and the control unit is configured to control the driving of the cooling fan based on a temperature value that is detected by the temperature sensor.

6. The cooling apparatus of claim 5, wherein the temperature sensor comprises a thermistor.

7. The cooling apparatus of claim 3, wherein the housing comprises one or more air outlet holes.

8. The cooling apparatus of claim 1, wherein the body comprises at least one connector unit, and the ODD module is connected with the at least one connector unit.

9. The cooling apparatus of claim 8, wherein the connector unit comprises a universal serial bus (USB) slot.

10. The cooling apparatus of claim 1, wherein, in response to the computer being disposed at a surface of the body in which the one or more ventilation holes are formed, an air flow that is generated by the cooling fan module passes through the one or more ventilation holes and moves toward the computer.

11. An optical disc drive, comprising:
a tray configured to receive an optical disc;
a rotator configured to rotate the optical disc;
an optical pickup configured to slide in a radial direction of the optical disc and to read and/or write signals to and/or from the optical disc during rotation; and
a controller configured to control a cooling apparatus of a computer based on a temperature of the computer.

12. The optical disc drive of claim 11, wherein the optical disc drive is included within the cooling apparatus.

13. The optical disc drive of claim 11, further comprising a temperature sensor configured to detect the temperature of the computer.

14. The optical disc drive of claim 11, wherein the controller is further configured to adjust the speed of the rotator based on a change in temperature of the computer.

15. The optical disc drive of claim 11, wherein the controller is further configured to transmit a driving current to the cooling apparatus to start the cooling apparatus, in response to an increase in temperature of the computer.

16. The optical disc drive of claim 11, wherein the controller is further configured to disable a driving current to the cooling apparatus, in response to a decrease in temperature of the computer.
